(19) United States
(12) Patent Application Publication
(10) Pub. No.: US 2025/0321244 A1
(43) Pub. Date: Oct. 16, 2025

(54) ACCELEROMETER WITH PROOF MASS DISPLACEMENT SENSITIVITY REDUCTION FEATURE

(71) Applicant: Honeywell International Inc., Charlotte, NC (US)

(72) Inventor: Paul W. Dwyer, Seattle, WA (US)

(21) Appl. No.: 18/633,094

(22) Filed: Apr. 11, 2024

(51) Int. Cl. G01P 15/13; G01P 15/125

(52) U.S. Cl. CPC G01P 15/132; G01P 15/125

(57) ABSTRACT

An accelerometer system including: a first magnetic assembly including a first pole piece; a second magnetic assembly including a second pole piece, wherein a physical shape of the second pole piece is different than a physical shape of the first pole piece; and a proof mass assembly including: a proof mass between the first magnetic assembly and the second magnetic assembly. A first magnetic flux flows from the first magnetic assembly to the first pole piece, wherein a magnitude of the first magnetic flux across the first coil is based on the physical shape of the first pole piece; A second magnetic flux flows from the second magnetic assembly to the second pole piece, and wherein a magnitude of the second magnetic flux is based on the physical shape of the second pole piece.

### TECHNICAL FIELD

This disclosure relates to accelerometers.

### BACKGROUND

Accelerometers function by detecting a displacement of a proof mass under inertial forces. Some accelerometers include a capacitive pick-off system. For example, electrically conductive material (e.g., a capacitor plate) may be deposited on the upper surface of the proof mass, and similar electrically conductive material may be deposited on the lower surface of the proof mass. An acceleration or force applied along the sensitive axis of the accelerometer causes the proof mass to deflect either upwardly or downwardly causing the distance (e.g., a capacitive gap) between the pick-off capacitance plates and upper and lower non-moving members to vary. This variance in the capacitive gap causes a change in the capacitance of the capacitive elements, which is representative of the displacement of the proof mass along the sensitive axis. The change in the capacitance may be used as a displacement signal, which may be applied to a servo system that includes one or more electromagnets (e.g., a force-rebalancing coil) to return the proof mass to a null or at-rest position.

### SUMMARY

In general, the disclosure is directed to devices, systems, and techniques for reducing the effects of vibration of an accelerometer system on the accuracy and sensitivity of the accelerometer system. Vibrations experienced by an example accelerometer system determining an acceleration of one or more devices may affect the induction of magnets within the accelerometer system, which may affect the scale factor of the accelerometer system and the accuracy of an output produced by the accelerometer system. In some examples, minor variations in the components of the accelerometer system may lead to imbalance in the magnetic flux applied on opposing sides of proof mass. This imbalance may lead to reduced accuracy in the output produced by the accelerometer system, e.g., as proof mass moves out of the null position.

The devices, systems, and techniques described in this disclosure alter the distribution of magnetic flux about the proof mass, e.g., to reduce the imbalance in the magnetic flux and minimize net changes in magnetic flux within the system, e.g., due to movement of the proof mass within the accelerometer. This may lead to a reduction of the effects of vibration on the output of the accelerometer system, thereby increasing the accuracy of the accelerometer system compared to other accelerometer systems.

In some examples, this disclosure describes an accelerometer system comprising: a first magnetic assembly comprising a first pole piece, a first magnet configured to generate a first magnetic flux, and a first excitation ring; a second magnetic assembly comprising a second pole piece, a second magnet configured to generate a second magnetic flux, and a second excitation ring, wherein a physical shape of the second pole piece is different than a physical shape of the first pole piece; a proof mass assembly comprising: a proof mass between the first magnetic assembly and the second magnetic assembly; a first coil disposed around the first pole piece, wherein the first magnetic flux flows from the first excitation ring to the first pole piece across the first coil, and wherein a magnitude of the first magnetic flux across the first coil is based on the physical shape of the first pole piece; and a second coil disposed around the second pole piece, wherein the second magnetic flux flows from the second excitation ring to the second pole piece across the second coil, and wherein a magnitude of the second magnetic flux across the second coil is based on the physical shape of the second pole piece; and processing circuitry configured to: cause a first current to flow through the first coil to apply a first Lorentz force to the proof mass; and cause a second current to flow through the second coil to apply a second Lorentz force to the proof mass.

In some examples, this disclosure describes an accelerometer system comprising: a first magnetic assembly comprising a first pole piece, a first magnet configured to generate a first magnetic flux, and a first excitation ring; a second magnetic assembly comprising a second pole piece, a second magnet configured to generate a second magnetic flux, and a second excitation ring; a proof mass assembly comprising: a proof mass between the first magnetic assembly and the second magnetic assembly; a first coil disposed around the first pole piece, wherein the first magnetic flux flows from the first excitation ring to the first pole piece across the first coil, and wherein a magnitude of the first magnetic flux across the first coil is based on a physical shape of the first pole piece; and a second coil disposed around the second pole piece, wherein the second magnetic flux flows from the second excitation ring to the second pole piece across the second coil, and wherein a magnitude of the second magnetic flux across the second coil is based on a physical shape of the second pole piece; and processing circuitry configured to: cause a first current to flow through the first coil to apply a first Lorentz force to the proof mass; and cause a second current to flow through the second coil to apply a second Lorentz force to the proof mass, wherein at least one pole piece of the first pole piece or the second pole piece defines a chamfer extending around an outer perimeter of the at least one pole piece.

In some examples, this disclosure describes an accelerometer system comprising: a first magnetic assembly comprising a first pole piece, a first magnet configured to generate a first magnetic flux, and a first excitation ring; a second magnetic assembly comprising a second pole piece, a second magnet configured to generate a second magnetic flux, and a second excitation ring, wherein a physical shape of the second excitation ring is different than a physical shape of the first excitation ring; a proof mass assembly comprising: a proof mass between the first magnetic assembly and the second magnetic assembly; a first coil disposed around the first pole piece, wherein the first magnetic flux flows from the first excitation ring to the first pole piece across the first coil, and wherein a magnitude of the first magnetic flux across the first coil is based on the physical shape of the first excitation ring; and a second coil disposed around the second pole piece, wherein the second magnetic flux flows from the second excitation ring to the second pole piece across the second coil, and wherein a magnitude of the second magnetic flux across the second coil is based on the physical shape of the second excitation ring; and processing circuitry configured to: cause a first current to flow through the first coil to apply a first Lorentz force to the proof mass; and cause a second current to flow through the second coil to apply a second Lorentz force to the proof mass.

The summary is intended to provide an overview of the subject matter described in this disclosure. It is not intended to provide an exclusive or exhaustive explanation of the systems, device, and methods described in detail within the accompanying drawings and description below. Further details of one or more examples of this disclosure are set forth in the accompanying drawings and in the description below. Other features, objects, and advantages will be apparent from the description and drawings, and from the claims.

### BRIEF DESCRIPTION OF DRAWINGS

FIG. 1 is a block diagram illustrating an accelerometer system, in accordance with one or more techniques of this disclosure.

FIG. 2 is a conceptual diagram illustrating a side cutaway view of an example of the accelerometer system of FIG. 1.

FIG. 3 is a conceptual diagram illustrating the proof mass and pole pieces of the accelerometer system of FIG. 2.

FIG. 4 is a conceptual diagram illustrating a side cutaway view of another example of the accelerometer system of FIG. 1.

FIG. 5 is a flow chart illustrating an example technique for determining an acceleration using the electromagnetic accelerometer of FIG. 1.

FIG. 6 is a flow chart illustrating an example technique for manufacturing the electromagnetic accelerometer of FIG. 1

Like reference characters denote like elements throughout the description and figures.

### DETAILED DESCRIPTION

This disclosure is directed to devices, systems and techniques for determining an acceleration of an object using an accelerometer system. For example, the accelerometer system may be an electromagnetic accelerometer system configured to precisely measure acceleration values. The electromagnetic accelerometer system uses a combination of electrical signals and magnetic signals to determine the acceleration of the object. For example, the accelerometer system may include a magnetic pole piece, an electrical coil, a non-moving member, and a proof mass. A magnetic flux may travel from the pole piece, through the coil to the non-moving member, and back to the proof mass. An electrical current may flow through the coil. The accelerometer system may generate a Lorentz force based on the magnetic flux and the electrical current, the Lorentz force representing a servo effect which prevents a displacement of the proof mass.

In some cases, the accelerometer system is configured to measure the acceleration of the object in real-time or near real-time, such that processing circuitry may analyze the acceleration of the object over a period of time to determine a positional displacement of the object during the period of time. For example, the accelerometer system may be a part of an inertial navigation system (INS) for tracking a position of an object based, at least in part, on an acceleration of the object. Additionally, the accelerometer system may be located on or within the object such that the accelerometer system accelerates with the object. As such, when the object accelerates, the acceleration system (including the proof mass) accelerates with the object. Since acceleration over time is a derivative of velocity over time, and velocity over time is a derivative of position over time, processing circuitry may, in some cases, be configured to determine the position displacement of the object by performing a double integral of the acceleration of the object over the period of time. Determining a position of an object using the accelerometer system located on the object—and not using a navigation system external to the object (e.g., a global navigation satellite system (GNSS))—may be referred to as “dead reckoning.”

The accelerometer system may experience vibrations during acceleration of the object. For example, the object may vibrate during movement and/or acceleration and the vibrations may be transmitted into the accelerometer system. Under vibration, the proof mass may move in an out of a null position.

In a balanced accelerometer system, the proof mass is maintained at the null position within the accelerometer system. In some examples, e.g., due to variations in the components used to manufacture an accelerometer system and/or differences in inductance of the magnets, the accelerometer system may include imbalanced magnetic flux loops. The imbalance in the magnetic flux loop may lead to displacement of proof mass from the null position, which may affect the accuracy of the acceleration values determined by the accelerometer system. For example, the variations in the components between magnetic assemblies on opposing sides of the proof mass may generate different Lorentz forces, which may lead to an imbalance of Lorentz forces on opposing sides of the proof mass, thereby allowing the proof mass to displace.

The devices, systems, and techniques described herein reduce the effects of proof mass displacement on the accuracy of the acceleration values determined by the accelerometer system. The devices, systems, and techniques described herein compensate for the displacement of the proof mass by balancing magnetic flux loops of the accelerometer system to reduce a net change in magnetic flux in the accelerometer system due to the movement of the proof mass. The devices, systems, and techniques described herein account for existing asymmetries in the accelerometer system by redistributing the flow of magnetic flux within the accelerometer system via one or more features within the accelerometer system. The redistribution of the flow of magnetic flux may create asymmetry in the magnetic flux loops which counteract other existing asymmetry in the accelerometer system to balance the accelerometer system. The features may increase the symmetry in the magnetic flux loops between different magnetic assemblies of the accelerometer system, which may improve the balance between the Lorentz forces acting on the proof mass, thereby reducing and/or eliminating the effects of the movement of the proof mass on the Lorentz forces and, by extension, the acceleration values outputted by the accelerometer system.

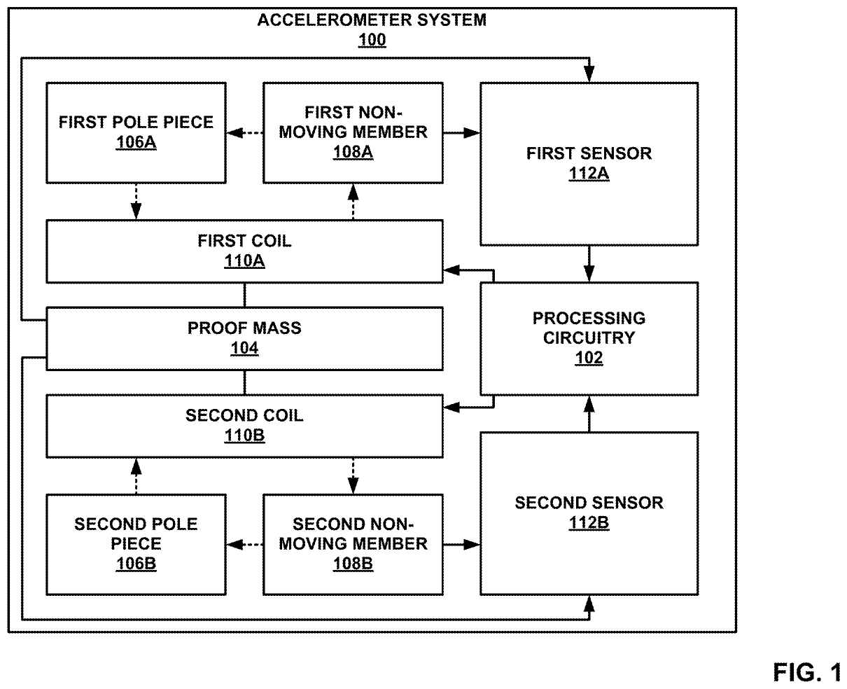

FIG. 1 is a block diagram illustrating an accelerometer system 100, in accordance with one or more techniques of this disclosure. As illustrated in FIG. 1, accelerometer system 100 includes processing circuitry 102, proof mass 104, first pole piece 106A, second pole piece 106B (collectively, “pole pieces 106”), first non-moving member 108A, second non-moving member 108B (collectively, “non-moving members 108”), first coil 110A, second coil 110B (collectively, “coils 110”), first sensor 112A, and second sensor 112B (collectively, “sensors 112”).

Accelerometer system 100 is configured to determine an acceleration associated with an object (not illustrated in FIG. 1) based on a magnitude of one or more electrical signals delivered to coils 110, the electrical signals preventing proof mass 104 from displacing from a null position. For example, first sensor 112A may be configured to generate a first sense signal which indicates a size of a gap between proof mass 104 and first non-moving member 108A and second sensor 112B may be configured to generate a second sense signal which indicates a size of a gap between proof mass 104 and second non-moving member 108B. Processing circuitry 102 may generate a first electrical signal for delivery to first coil 110A based on the first sense signal and generate a second electrical signal for delivery to second coil 110B based on the second sense signal. The first electrical signal and the second electrical signal may induce one or more Lorentz forces which prevent the displacement of proof mass 104 from a null position. For example, the first electrical signal may induce a first Lorentz force and the second electrical signal may induce a second Lorentz force, wherein the first Lorentz force and the second Lorentz force interact with proof mass 104 to inhibit displacement of proof mass 104 from the null position.

A Lorentz force represents a force caused by an interaction of an electric fields and a magnetic field. For example, a Lorentz force may be defined by a cross-product of an electrical field and a magnetic field, where the direction of the Lorentz force depends on the direction of the electrical field and the direction of the magnetic field, and where the magnitude of the Lorentz force depends on the magnitude of the electrical field and the magnitude of the magnetic field.

Processing circuitry 102 may include one or more processors that are configured to implement functionality and/or process instructions for execution within accelerometer system 100. For example, processing circuitry 102 may be capable of processing instructions stored in a memory. Processing circuitry 102 may include, for example, microprocessors, digital signal processors (DSPs), application specific integrated circuits (ASICs), field-programmable gate arrays (FPGAs), or equivalent discrete or integrated logic circuitry, or a combination of any of the foregoing devices or circuitry. Accordingly, processing circuitry 102 may include any suitable structure, whether in hardware, software, firmware, or any combination thereof, to perform the functions ascribed herein to processing circuitry 102.

A memory (not illustrated in FIG. 1) may be configured to store information within accelerometer system 100 during operation. The memory may include a computer-readable storage medium or computer-readable storage device. In some examples, the memory includes one or more of a short-term memory or a long-term memory. The memory may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, the memory is used to store program instructions for execution by processing circuitry 102.

Processing circuitry 102 may generate the first electrical signal and the second electrical signal as a part of a one or more negative feedback loops which maintain proof mass 104 in the null position. Processing circuitry 102, first coil 110A, and first sensor 112A represent components of a first negative feedback loop. The first negative feedback loop may maintain a width of the gap between proof mass 104 and first non-moving member 108A at a first null width. For example, first sensor 112A may generate the first sense signal which indicates a capacitance value. The capacitance value is correlated with the width of the gap between proof mass 104 and first non-moving member 108A and delivers the first sense signal to processing circuitry 102. Processing circuitry 102 may generate the first electrical signal based on the first sense signal and deliver the first electrical signal to first coil 110A in order to maintain the capacitance value of the first sense signal at a first null capacitance value. By generating the first electrical signal in order to maintain the capacitance value of the first sense signal at the first null capacitance value, processing circuitry 102 maintains a width of the gap between the proof mass 104 and the first non-moving member 108A at the first null width.

Processing circuitry 102, second coil 110B, and second sensor 112B represent components of a second negative feedback loop. The second negative feedback loop may maintain a width of the gap between proof mass 104 and second non-moving member 108B at a second null width. For example, second sensor 112B may generate the second sense signal which indicates a second capacitance value. The capacitance value is correlated with the width of the gap between proof mass 104 and second non-moving member 108B and delivers the second sense signal to processing circuitry 102. Processing circuitry 102 may generate the second electrical signal based on the second sense signal and deliver the second electrical signal to second coil 110B in order to maintain the capacitance value of the second sense signal at a second null capacitance value. By generating the second electrical signal in order to maintain the second capacitance value of the second sense signal at the second null capacitance value, processing circuitry 102 maintains a width of the gap between the proof mass 104 and the second non-moving member 108B at the second null width.

Additionally, by maintaining the width of the gap between the proof mass 104 and the first non-moving member 108A at the first null width and maintaining the width of the gap between the proof mass 104 and the second non-moving member 108B at the second null width, processing circuitry 102 may maintain a position of proof mass 104 at a null position relative to non-moving members 108.

When an acceleration of accelerometer system 100 along a sense axis changes, the resulting acceleration force applied to proof mass 104 may change. Consequently, processing circuitry 102 may change a magnitude of the first electrical signal delivered to first coil 110A and the second electrical signal delivered to second coil 110B in order to prevent a displacement of proof mass 104 relative to non-moving members 108. In one example, the acceleration along the sense axis may increase from a first acceleration value to a second acceleration value. The processing circuitry 102 may change the magnitude of the first electrical signal and change the magnitude of the second electrical signal in order to account for the change in acceleration so that proof mass 104 remains in the null position relative to non-moving members 108. Processing circuitry 102 may determine the acceleration of accelerometer system 100 along the sense axis based on the magnitude of the first electrical signal delivered to first coil 110A and the magnitude of the second electrical signal delivered to second coil 110B.

In some examples, the magnitude of the first electrical signal delivered to first coil 110A is proportional to the acceleration along the sense axis. In some examples, the magnitude of the second electrical signal delivered to second coil 110B is proportional to the acceleration along the sense axis. As such, an increase in the magnitude of the first electrical signal may correspond to an increase in the acceleration along the sense axis and an increase in the magnitude of the second electrical signal may correspond to an increase in the acceleration along the sense axis. Alternatively, a decrease in the magnitude of the first electrical signal may correspond to a decrease in the acceleration along the sense axis and a decrease in the magnitude of the second electrical signal may correspond to a decrease in the acceleration along the sense axis.

Accelerometer system 100 may include a first magnetic flux loop and a second magnetic flux loop. The first magnetic flux loop may include first pole piece 106A, first non-moving member 108A, and first coil 110A. Within the first magnetic flux loop, a first magnetic flux may travel from first pole piece 106A through first coil 110A to first non-moving member 108A. The first magnetic flux then travels through first non-moving member 108A back to first pole piece 106A. In some examples, first pole piece 106A may include a first magnet which generates the first magnetic flux. The second magnetic flux loop may include second pole piece 106B, second non-moving member 108B, and second coil 110B. Within the second magnetic flux loop, a second magnetic flux may travel from second pole piece 106B through second coil 110B to second non-moving member 108B. The second magnetic flux then travels through second non-moving member 108B back to second pole piece 106B. In some examples, second pole piece 106B may include a second magnet which generates the second magnetic flux.

Accelerometer system 100 may represent a servo system which counter-balances acceleration along the sense axis with Lorentz forces parallel to the sense axis. For example, if accelerometer system 100 accelerates along the sense axis, the acceleration may apply an acceleration force to the proof mass 104, where the acceleration force is applied to proof mass 104 in an opposite direction of the acceleration of accelerometer system 100. Processing circuitry 102 delivers the first electrical signal to first coil 110A and delivers the second electrical signal to second coil 110B in order to generate one or more Lorentz forces which counter-balance the acceleration force resulting from the acceleration along the sense axis. That is, the one or more Lorentz forces are applied to proof mass 104 in an opposite direction to the acceleration force, such that proof mass 104 is not displaced from a null position by the acceleration force. The magnitude of the acceleration force changes based on the magnitude of the acceleration along the sense axis. As such, to prevent the displacement of proof mass 104 from the null position, processing circuitry 102 changes the magnitude of the first electrical signal delivered to first coil 110A and the magnitude of the second electrical signal delivered to second coil 110B in order to change the magnitude of the one or more Lorentz forces which counter-balance the acceleration signal.

Lorentz forces are forces which arise from an interaction between an electrical field and a magnetic field. As discussed above, accelerometer system 100 includes a first magnetic flux loop and a second magnetic flux loop. The first magnetic flux loop includes a passage of a first magnetic flux from the pole piece 106A to first non-moving member 108A through first coil 110A. The first electrical signal flows through first coil 110A. The first magnetic flux and the first electrical signal may cause a first Lorentz force to be applied to proof mass 104 in an opposite direction of the acceleration force applied to proof mass 104 due to the acceleration along the sense axis. Additionally, the second magnetic flux loop includes a passage of a second magnetic flux from the second pole piece 106B to second non-moving member 108B through second coil 110B. The second electrical signal flows through second coil 110B. The second magnetic flux and the second electrical signal may cause a second Lorentz force to be applied to proof mass 104 in an opposite direction of the acceleration force applied to proof mass 104 due to the acceleration along the sense axis.

In some examples, due to the variations in components of accelerometer system 100 (e.g., in pole pieces 106, non-moving members 108, and/or coils 110), and/or a torque on proof mass 104, there may be asymmetry in the magnetic flux generated by pole pieces 106. The asymmetry in the magnetic flux may lead to an imbalance of Lorentz forces induced by the electrical signals and applied on proof mass 104, e.g., thereby enabling proof mass 104 to move within accelerometer system 100. The movement of proof mass 104 may affect the output of accelerometer system 100.

Accelerometer system 100 may include one or more of pole pieces 106 or non-moving members 108 with features configured to adjust distribution of magnetic flux within accelerometer system 100, e.g., to improve the symmetry of the magnetic flux and balance of Lorentz forces induced within accelerometer system 100. Components such as pole pieces 106 and/or non-moving members 108 may include one or more features to alter the reluctance of the components. The one or more features may include, but are not limited to, chamfers, fillets, differences in material, differences in dimensions, channels, openings, cavities, protrusions, or the like.

The one or more features may alter the reluctance of the components to create asymmetry in the magnetic fields at opposite ends of proof mass 104. For example, the one or more features may cause the first magnetic flux to be different from the second magnetic flux. The changes in reluctance of the components may the paths of travel of magnetic flux through the components. For example, the changes in reluctance of the components may reduce concentration of magnetic flux at one or more locations within accelerometer system 100 (e.g., along surfaces and/or edges closest to proof mass 104 and/or coils 110). The adjusted paths of travel may create an asymmetry in the magnetic flux across the opposite ends of proof mass 104, which may counterbalance the asymmetry in the magnetic flux due to the variations in components and/or torque on proof mass 104, e.g., as previously discussed herein.

The counterbalancing of the asymmetries in the magnetic flux (e.g., asymmetry resulting from the reluctance-altering features against asymmetry resulting from variations in components and/or torque on proof mass 104) may lead to a balance in magnetic flux and Lorentz forces across opposite ends of proof mass 104. The balance in magnetic flux and Lorentz forces may minimize and/or eliminate net changes in magnetic flux due to displacement of proof mass 104, which may improve the accuracy of outputs by accelerometer system 100. For example, accelerometer system 100 may reduce a net change in magnetic flux within accelerometer system 100 due to displacement of proof mass 104. For example, by adjusting the distribution of magnetic flux through coils 110, accelerometer system 100 may experience a gain in magnetic flux through one of coils 110 (e.g., through first coil 110A) as a result of displacement of proof mass 104 that is equal or substantially equal to loss in magnetic flux through another of coils 110 (e.g., through second coil 110B) as a result of the same displacement of proof mass 104.

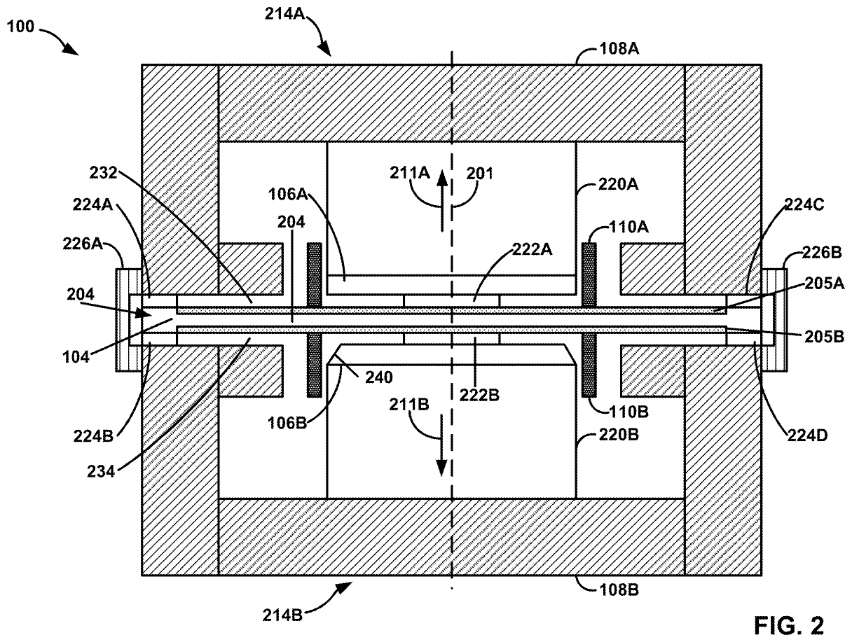

FIG. 2 is a conceptual diagram illustrating a side cutaway view of accelerometer system 100, in accordance with one or more techniques of this disclosure. As seen in FIG. 2, accelerometer system 100 includes proof mass assembly 204, first pole piece 106A, second pole piece 106B, first non-moving member 108A, second non-moving member 108B, first coil 110A, second coil 110B, first magnet 220A, and second magnet 220B (collectively, “magnets 220”). Proof mass assembly 204 includes proof mass 104, first capacitive plate 205A, and second capacitive plate 205B (collectively, “capacitive plates 205”). In the example of FIG. 2, accelerometer system 100 further includes center raised pads 222A-222B (collectively, “center raised pads 222”), outer raised pads 224A-224D (collectively, “outer raised pads 224”), first band 226A, second band 226B (collectively, “bands 226”), first capacitive gap 232, and second capacitive gap 234. In the example of FIG. 2, accelerometer system 100 may include accelerometer supports 214A-214B (collectively, “accelerometer supports 214”), which may be formed by a combination of pole pieces 106, non-moving members 108, and magnets 220.

Accelerometer system 100 may be configured to sense an acceleration along sense axis 201. For example, accelerometer system 200 may be configured to sense an acceleration along sense axis 201 in a first direction 211A. In some cases, accelerometer system 200 precisely determines a magnitude of the acceleration along the sense axis 201 in the first direction 211A in real time or near-real time such that processing circuitry (not illustrated in FIG. 2) may track a position of accelerometer system 200 using dead reckoning. As seen in FIG. 2, proof mass assembly 204 is suspended between first non-moving member 108A and second non-moving member 108B by center raised pads 222 and outer raised pads 224. In some examples, the processing circuitry may receive a first sense signal indicative of a width of first capacitive gap 232 and receive a second sense signal indicative of a width of second capacitive gap 234. In turn, the processing circuitry may deliver a first electrical signal to first coil 110A and deliver a second electrical signal to second coil 110B in order to prevent a displacement of proof mass 104 in response to an acceleration of accelerometer system 100 along sense axis 201. The magnitude of the first electrical signal and the magnitude of the second electrical signal may be correlated with the magnitude of the acceleration.

Non-moving members 108 may be attached to (e.g., clamped) center raised pads 222 and outer raised pads 224, securing proof mass assembly 204 between first non-moving member 108A and second non-moving member 108B. The term “non-moving member” may refer to a member representing a reference position by which a position of proof mass assembly 204 may be compared. In other words, the position of proof mass assembly 204 may represent a position of proof mass assembly 204 relative to non-moving members 108. In some examples, non-moving members 108 include dual metal materials, which may be part of a magnetic flux loop. In some examples, non-moving members 108 may be similar to stators of a variable capacitor.

Coils 110 may conduct electricity such that electrical signals flow through coils 110. For example, a first electrical signal may flow through a path of first coil 110A and a second electrical signal may flow through a path of second coil 110B. The path of each of coils 110 may define a circular, oval, square, triangular, or other polygonal path. Each of coils 110 extend fully around an outer surface of a corresponding pole piece of pole pieces 106, e.g., such that the first electrical signal flows around the outer surface of pole piece 106A through first coil 110A and the second electrical signal flows around the outer surface of pole piece 106B through second coil 110B.

Bands 226 are a metal pieces which fasten first non-moving member 108A to second non-moving member 108B. In some examples, bands 226 may be attached to (e.g., bonded with epoxy) non-moving members 108, when non-moving members 108 are attached to proof mass assembly 204 by center raised pads 222 and outer raised pads 224. Accelerometer system 100 includes first capacitive gap 232 and second capacitive gap 234. First capacitive gap 232 represents a gap between first capacitive plate 205A and first non-moving member 108A, second capacitive gap 234 represents a gap between second capacitive plate 205B and second non-moving member 108B. First capacitive plate 205A may generate a first sense signal which indicates a first capacitance value. The first capacitance value is correlated with a width of first capacitive gap 232. Second capacitive plate 205B may generate a second sense signal which indicates a second capacitance value. The second capacitance value is correlated with a width of second capacitive gap 234. In this way, first capacitive plate 205A may represent first sensor 112A of FIG. 1 and second capacitive plate 205B may represent second sensor 112B of FIG. 1. Processing circuitry (not illustrating in FIG. 2) may receive the first sense signal and the second signal and control electrical signals delivered to coils 110 based on the first sense signal and the second sense signal.

A null width of first capacitive gap 232 may, in some examples, be defined by a width of outer raised pads 224 and center raised pads 222. In some examples, the null width of first capacitive gap 232 is within a range from 0.0127 millimeters (mm) (e.g., about 0.0005 inches (in)) to 0.0635 mm (e.g., about 0.0025 in). A null width of second capacitive gap 234 may, in some examples, be defined by a width of outer raised pads 224 and center raised pads 222. In some examples, the null width of second capacitive gap 234 is within a range from 0.0127 mm (e.g., about 0.0005 in) to 0.0635 mm (e.g., about 0.0025 in). When the width of first capacitive gap 232 is at the null width of first capacitive gap 232 and the width of second capacitive gap 234 is at the null width of second capacitive gap 234, proof mass 104 may be located at a null position. That is, proof mass 104 may be located at the null position such that the processing circuitry is configured to determine the acceleration along sense axis 201 based on the first electrical signal delivered to first coil 110A and the second electrical signal delivered to second coil 110B.

In some examples, first capacitive gap 232 may have a first capacitance value. The processing circuitry may detect the first capacitance value of first capacitive gap 232, which in a closed-loop differential capacitance configuration can be detected and used by the processing circuitry to determine the acceleration of accelerometer system 100. Additionally, second capacitive gap 234 may have a second capacitance value. The processing circuitry may detect the second capacitance value of second capacitive gap 234, which in a closed-loop differential capacitance configuration can be detected and used by the processing circuitry to determine the acceleration of accelerometer system 100. In some examples, an increase in a width of first capacitive gap 232 and a decrease in a width of second capacitive gap 234 may be indicative of an acceleration of accelerometer system 100 in first direction 211A. Conversely, an increase in the width of second capacitive gap 234 and a decrease in the width of first capacitive gap 232 may be indicative of an acceleration of accelerometer system 200 in the second direction 211B. The processing circuitry may deliver the first electrical signal to first coil 110A and deliver the second electrical signal to second coil 110B in order to counter-balance a displacement of proof mass 104 from the null position. The magnitude of the first electrical signal and the magnitude of the second electrical signal may be correlated with the magnitude of the acceleration along sense axis 201.

Magnets 220 are magnets for providing a magnetic field to drive magnetic circuits of magnets 220, pole pieces 106, coils 110, and non-moving members 108. In some examples, magnets 220 may be made of Alnico, samarium-cobalt, neodymium-iron-boron, or other such materials. In some examples, magnets 220 may receive the forces and/or strains transmitted from non-moving members 208 caused by the construction of accelerometer system 100. In some examples, magnets 220 may be part of a zero gauge configuration of accelerometer system 100.

Pole pieces 106 are magnetic structures that enables the magnetic field of magnets 220 to be focused and drive the magnetic circuit of magnets 220, pole pieces 106, coils 110, and non-moving members 108. For example, pole pieces 106 may be magnetic structures that enable the magnetic field of the magnet to turn a corner and flow through coils 110. In these examples, by allowing the magnetic field of magnets 220 to go through coils 110, the magnetic field of magnets 220 may enter non-moving members 108 and flow around to the opposite side of the magnet through non-moving members 108, and flow back through the magnet to the proof mass completing the magnetic circuit. For example, a first magnetic circuit may represent a magnetic flux loop in which a first magnetic flux passes from first magnet 220A to first pole piece 106A. The first magnetic flux travels from first pole piece 106A to first non-moving member 108A through first coil 110A. Then, the first magnetic flux travels through first non-moving member 108A back to first magnet 220A in order to complete the first magnetic circuit. A second magnetic circuit may represent a magnetic flux loop in which a second magnetic flux passes from second magnet 220B to second pole piece 106B. The second magnetic flux travels from second pole piece 106B to second non-moving member 108B through second coil 110B. Then, the second magnetic flux travels through second non-moving member 108B back to second magnet 220B in order to complete the second magnetic circuit.

In some examples, pole pieces 106 may be part of a zero gauge configuration of accelerometer system 100. In some examples, pole pieces 106 may be made from a permeable material such as invar, Mu Metal, Permalloy, or other such material.

In some examples, accelerometer system 100 may include coils 110 attached on each side of the proof mass. In some examples, accelerometer system 100 may include processing circuitry (not illustrated in FIG. 2) configured to deliver a first electrical signal and a second electrical signal to coils 110 in order to position proof mass 104 at the null position. In some examples, when accelerometer system 100 accelerates along sense axis 201, the processing circuitry may increase an electrical current magnitude of the first electrical signal and increase an electrical current magnitude of the second electrical signal to maintain the proof mass 104 at the null position. In this example, the electrical current magnitude of the first electrical signal and the electrical current magnitude of the second electrical signal are proportional to the magnitude of the acceleration along the sense axis 201.

Preventing proof mass 104 from displacing form the null position may be referred to herein as the “servo effect.” In some examples, the processing circuitry may cause one or more Lorentz forces to counter-balance an acceleration force applied to proof mass 104 such that proof mass 104 does not move from the null position. This means that the processing circuitry is configured to adjust the one or more Lorentz forces in real time or near-real time such that the one or more Lorentz forces counter-balance the acceleration force applied to proof mass 104 at any given time, thus constantly maintaining the proof mass 104 at the null position. The electrical signals required to induce the one or more Lorentz forces may be generated by the processing circuitry based on the first sense signal received from first capacitive plate 205A and the second sense signal received from the second capacitive plate 205B.

Coils 110 may be mounted on either side of proof mass 104 of proof mass assembly 204. In some examples, processing circuitry may modify the current in coils 110 to servo proof mass 104 to maintain the null position. Any acceleration of accelerometer system 100 will momentarily move the proof mass of proof mass assembly 204 out of the plane of the null position and the increase in current required to maintain proof mass 104 in the null position is proportional to the magnitude of the acceleration of accelerometer system 100 along sense axis 201.

Although FIG. 2 illustrates accelerometer system 100 with a capacitive plate and a coil on both sides of proof mass assembly 204 to form a combined capacitive pick-off system, it is understood that accelerometer system 100 may function with a capacitor plate and a coil on only one side of proof mass assembly 204. Similarly, although FIG. 2 illustrates accelerometer system 100 with a non-moving member on both sides of proof mass assembly 204 to form the combined capacitive pick-off system, it is understood that accelerometer system 100 may function a non-moving member and a capacitor plate on the same side of proof mass assembly 204.

As illustrated in FIG. 2, one or more pole pieces of pole pieces 106 may include feature 240 at or around a distal end of the pole piece. For example, as illustrated in FIG. 2, second pole piece 106B may include feature 240 extend around a distal edge of second pole piece 106B. Feature 240 may include, but is not limited to, a chamfer, a fillet, a recess, a channel, an opening, a protrusion or the like. While feature 240 is primarily described herein as being a chamfer, feature 240 may be any of the example features listed herein.

Feature 240 may remove a portion of the permeable material at or around a distal end of the corresponding pole piece 106 (e.g., second pole piece 106B). The distal end of the corresponding pole piece 106 refers to an end of pole piece 106 closest to proof mass assembly 204 along sense axis 201. In an example pole piece 106 without feature 240 (e.g., first pole piece 106A), the magnetic flux is concentrated at the distal edge of the pole piece 106 (e.g., the edge defining an outer perimeter of the distal end of the pole piece) and flows from the pole piece 106 to a corresponding coil 110 (e.g., first coil 110A) at the distal edge. Feature 240 removes the permeable material at the distal edge of the pole piece, which may redirect the flow of magnetic flux from second pole piece 106B to second coil 110B at a position along sense axis 201 that is further from proof mass assembly 204 than the distal end of second pole piece 106B. The redirection of magnetic flux flow may alter the distribution and density of the magnetic field of the second magnetic circuit, e.g., compared to the first magnetic circuit, thereby creating a first asymmetry between the first magnetic circuit and the second magnetic circuit. When the object is in motion, the first asymmetry may counterbalance a second asymmetry between the first and second magnetic circuits caused by variations in magnets 220, pole pieces 106, capacitive plates 205, non-moving members 108, bands 226, center raised pads 222, outer raised pads 224 within accelerometer system 100.

The counterbalance between the first and second asymmetries may balance the Lorentz forces applied on capacitive plates 205 and reduce net change in magnetic flux in accelerometer system 100. For example, due to the redistribution of magnetic flux through second pole piece 106B due to feature 240 counterbalancing other asymmetries within accelerometer system 100, any loss in first magnetic flux due to proof mass 104 displacing towards second non-moving member 108B may be counteracted by gains in the second magnetic flux, and vice versa. Consequently, there may be substantially no net change in magnetic flux within accelerometer system 100 resulting from displacement of proof mass 104, e.g., due to vibration(s) of accelerometer system 100 and/or due to torque(s) acting on proof mass 104.

While FIG. 2 only illustrates second pole piece 106B as including feature 240, first pole piece 106A may include a corresponding feature, e.g., to direct the flow of the first magnetic flux within the first magnetic circuit. In such examples, features on pole pieces 106 may be different (e.g., may define different dimensions, may be of different types), to cause the shape and/or structure of first pole piece 106A to be different from the shape and/or structure of second pole piece 106B, e.g., to define asymmetry between the first and second magnetic circuits.

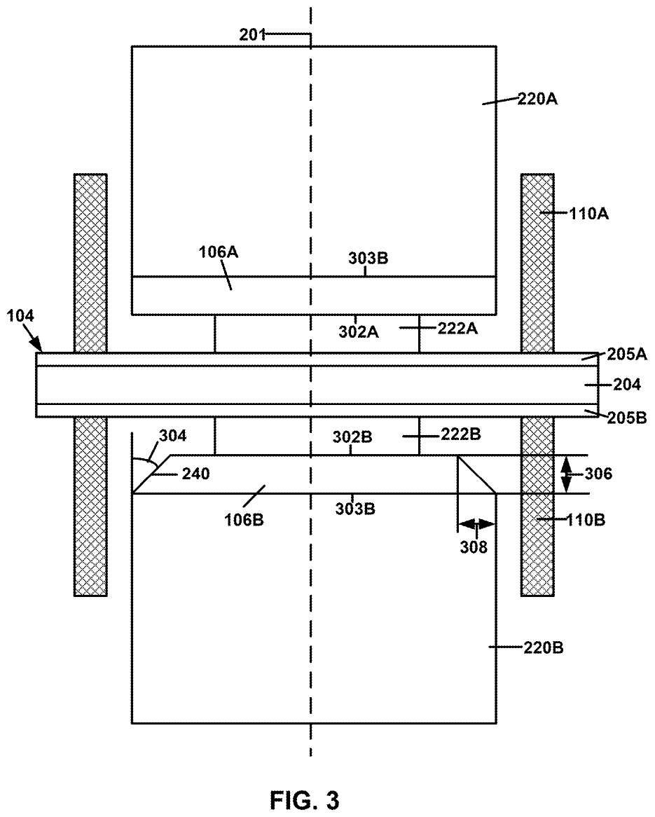

FIG. 3 is a conceptual diagram illustrating proof mass 104 and pole pieces 106 of the accelerometer system 100 of FIG. 2. While FIG. 2 illustrates and is primarily described herein with reference to only one of pole pieces 106 (e.g., second pole piece 106B), as including feature 240, in other example accelerometer systems, each of the pole pieces may include a corresponding feature. In such examples, the features on different pole pieces may be asymmetrical, e.g., to cause the different pole pieces of an example accelerometer system to be asymmetrical in shape and/or dimensions. While FIG. 2 is primarily described herein with respect to feature 240 being a chamfer around an edge of one of pole pieces 106, feature 240 may include, but is not limited to, rounds, fillets, recesses, channels, protrusions, inserts, or any other features disposed on or within the pole piece.

As illustrated in FIG. 2, feature 240 may be a chamfer extending around a distal edge of pole piece 106B. The chamfer may extending from a distal face 302B of pole piece 106B to proximal face 303B of pole piece 106B. In some examples, the chamfer extends from the distal face of pole piece 106B partially towards the proximal face of pole piece 106B.

As described herein, distal faces 302A, 302B of pole pieces 106 (collectively referred to herein as “distal faces 302”) refer to faces of each of pole pieces 106 that are relatively closer to proof mass 104 along sensing axis 201. As described herein, proximal faces 303A, 303B, of pole pieces 106 (collectively referred to herein as “proximal faces 303”) refer to faces of each of pole pieces 106 that are relatively further away from proof mass 104 along sensing axis 201 (e.g., compared to distal faces 302). Each of distal faces 302 may be connected to a corresponding center raised pad of center raised pads 222. Each of proximal faces 303 may be connected to a corresponding magnet of magnets 220. For example, distal face 302B of second pole piece 106B may be connected to a center raised pad 222B and proximal face 303B of second pole piece 106B may be connected to second magnet 220B.

Feature 240 may be defined by a chamfer angle 304 and a chamfer length 308. Chamfer angle 304 may define a depth of feature 240 along sensing axis 201. Chamfer angle 304 may be up to 60 degrees (e.g., up to 45 degrees). Chamfer length 308 may define a length of feature 240 along a reference axis orthogonal to sensing axis 201, e.g., along a reference axis parallel to distal face 302B of second pole piece 106B. Chamfer length 308 may be up to 0.6 millimeters (mm) (e.g., up to 0.53 mm, up to 0.595 mm). Feature 240 be symmetrical chamfer or asymmetrical around the circumference of distal face 302B.

Feature 240 may affect an amount of permeable material at or around distal face 302B of second pole piece 106B. For example, as illustrated in FIG. 2, feature 240 causes second pole piece 106B to include a reduced amount of permeable material at or around distal face 302B, compared to proximal face 303B. As magnetic flux flows from magnet 220B, through second pole piece 106B, and into second coil 110B, the magnetic flux may concentrate in regions with increased permeability, e.g., portions of second pole piece 106B without feature 240. In the example illustrated in FIG. 2, the magnetic flux may concentrate around a proximal edge of second pole piece 106B at or around proximal face 303B compared to the distal edge at or around distal face 302B, e.g., due to the increased permeability of the permeable material forming second pole piece 106B compared to air surrounding second pole piece 106B. In such examples, the distribution of magnetic flux within and/or around second pole piece 106B may be different than the distribution of magnetic flux within and/or around first pole piece 106A.

In some examples, where pole pieces 106 are substantially identical, there may be asymmetry between a first magnetic flux traveling through first pole piece 106A and first coil 110A and a second magnetic flux traveling through second pole piece 106B and second coil 110. For example, the first magnetic flux and the second magnetic flux do not change by a substantially similar amount in response to movement of accelerometer system 100. The asymmetry may be the results one or more differences between pole pieces 106, magnets 220, coils 110, non-moving members 108 (not pictured), or the like. For example, magnets 220 may have different minor loop slopes which may cause magnets 220 to exhibit different inductions as accelerometer system 100 inputs electrical current into coils 110.

Feature 240 may affect the amount and/or distribution of permeable material within second pole piece 106B to create an asymmetry between pole pieces 106. The asymmetry between pole pieces 106 may counterbalance the preexisting asymmetry to cause the first magnetic flux loop (extending through first magnet 220A, first pole piece 106A, and first coil 110A) to be symmetrical to second magnetic flux loop (extending through second magnet 220B, second pole piece 106B, and second coil 110B). The symmetry in the magnetic fields facilitate conservation of magnetic flux within accelerometer system 100 as proof mass 104 moves along sensing axis 201. For example, feature 240 may facilitate an equivalent change between a first magnetic flux of the first magnetic flux loop and a second magnetic flux of the second magnetic flux loop in response to movement of proof mass 104, such that there is substantially no net change in the net magnetic flux within accelerometer system 100. In such examples, the outputs of the accelerometer system 100 may not be adversely affected by the movement of proof mass 104, e.g., the scale factor of accelerometer system 100 may not be affected by the movement of proof mass 104.

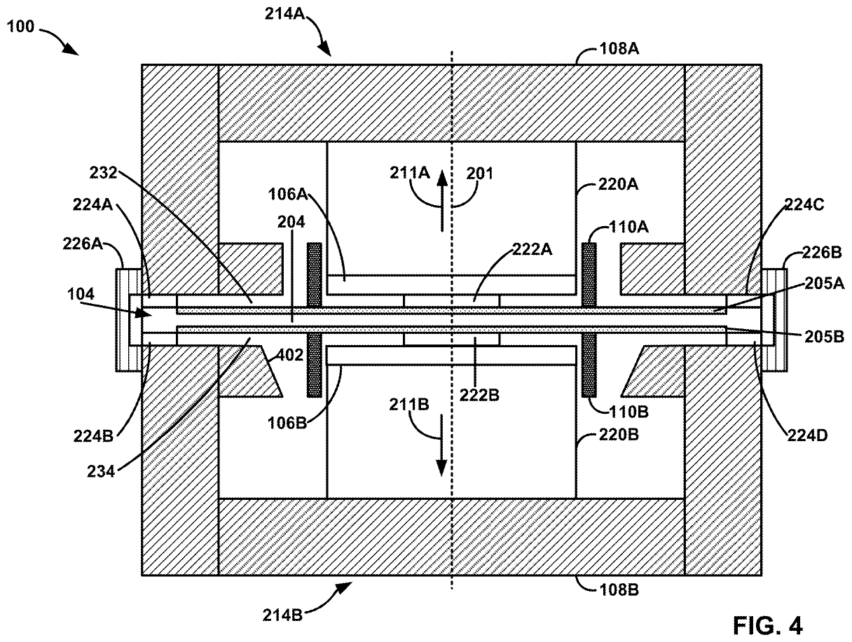

FIG. 4 is a conceptual diagram illustrating a side cutaway view of another example of accelerometer system 100 of FIG. 1. The example illustrated in FIG. 4 is substantially similar to the example illustrated and discussed in FIG. 2, except for the feature 402 disposed on one or more of non-moving members 108. Accelerometer system 100 may include feature 402 in addition to or instead of feature 240. Although feature 402 is primarily discussed herein with reference to only second non-moving member 108B including feature 402, each of non-moving members 108 may include a corresponding feature 402. In such examples, different features 402 on different non-moving members 108 may be asymmetrical, e.g., to cause non-moving members 108 to define different shapes and/or dimensions.

Similar to feature 240, feature 402 removes and/or adds permeable material to a non-moving member 108 (e.g., second non-moving member 108B), e.g., to adjust the flow of magnetic flux from second pole piece 106B through second coil 110B and into second non-moving member 108. Feature 402 may include one or more of a chamfer, a fillet, a round, a recess, an opening, a protrusion, an insert, or the like. As illustrated in FIG. 4, feature 402 removes material at or near a distal end of second non-moving member 108B (e.g., an end closes to proof mass 104 along sensing axis 201). As magnetic flux flows from second magnet 220B across second pole piece 106B and second coil 110B, the magnetic flux may concentrate away from feature 402 and towards a more proximal portion of second non-moving member 108 (e.g., due to an increased concentration of more permeable material at or around the more proximal portion). Feature 402 may thus alter the flow of magnetic flux through second non-moving member 108B, e.g., compared to first non-moving member 108A without feature 402, thereby creating asymmetry in the magnetic fields on opposite sides of proof mass 104. The asymmetry may counterbalance the preexisting symmetry in accelerometer system 100 (e.g., due to variations in pole pieces 106, non-moving member 108, coils 110, and/or magnets 220), thereby creating overall symmetry in the magnetic field within accelerometer system 100.

Compared to feature 240, feature 402 may alter an increased amount of permeable material within second non-moving member 108 to achieve a same redistribution of magnetic flux. For example, feature 402 may define larger chamfer angles and/or chamfer lengths than feature 240 and/or may remove a greater mass and/or volume of material compared to feature 240 to achieve a same redistribution of magnetic flux within accelerometer system 100. The difference between feature 240 and feature 402 may be due to, but is not limited to, an increased strength of a magnetic field at a position around pole pieces 106 and/or magnets 220 compared to a position more radially distant to pole pieces 106 and/or magnets 220.

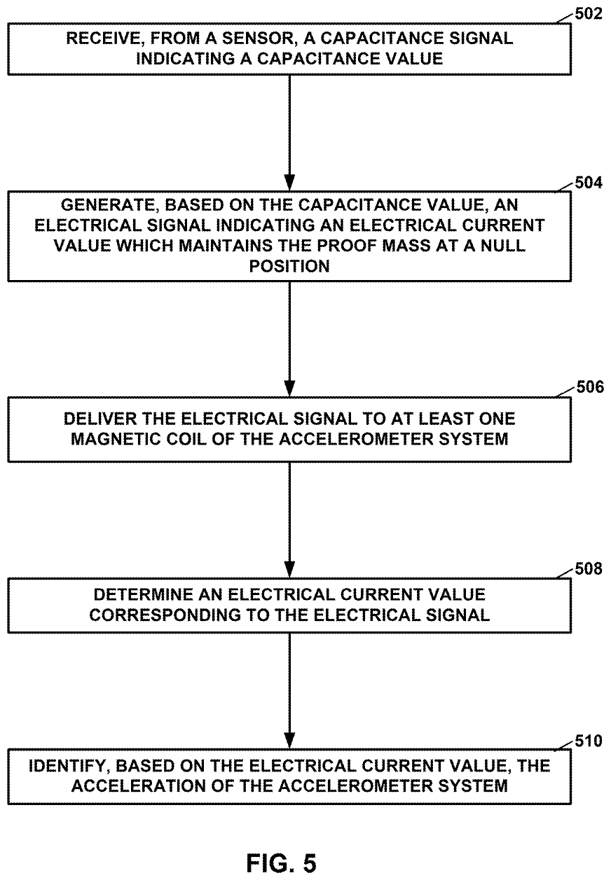

FIG. 5 is a flow diagram illustrating an example operation for determining an acceleration using an electromagnetic accelerometer, in accordance with one or more techniques of this disclosure. FIG. 5 is described with respect to accelerometer system 100, of FIG. 1. However, the techniques of FIG. 5 may be performed by different components of accelerometer system 100 or by additional or alternative devices.

Processing circuitry 102 may receive, from first sensor 112A, a first capacitance signal which indicates a capacitance value (502). In some examples, first sensor 112A may represent a first capacitive plate (e.g., first capacitive plate 205A of FIG. 2) located on a first side of proof mass 104. Processing circuitry 102 may generate, based on the capacitance signal, an electrical signal to include an electrical current value which maintains proof mass 104 at a null position (504). Processing circuitry 102 may deliver the electrical signal to first coil 110A (506). In some examples, processing circuitry 102 may deliver the electrical signal to first coil 110A such that first coil 110A applies a Lorentz force to proof mass 104, counteracting an acceleration force applied to proof mass 104.

Processing circuitry 102 may determine an electrical current value corresponding to the electrical signal (508). Subsequently, processing circuitry 102 may identify, based on the electrical current value, the acceleration of accelerometer system 100 based on the electrical current value (510). In other words, the strength of the electrical signal required to maintain proof mass 104 in a null position is correlated with the acceleration of accelerometer system 100 along a sense axis.

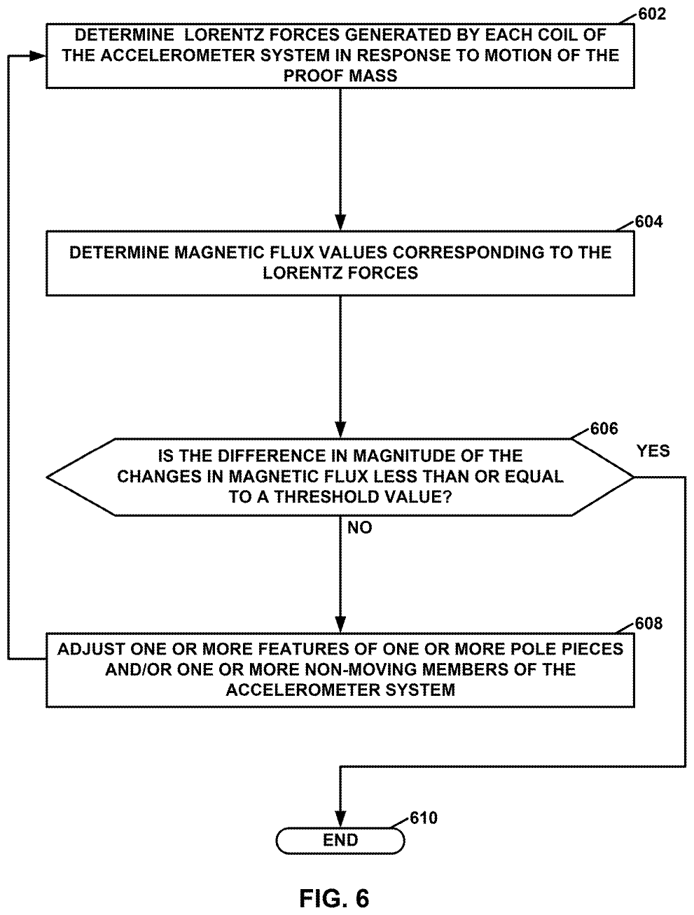

FIG. 6 is a flow chart illustrating an example technique for manufacturing the electromagnetic accelerometer of FIG. 1. FIG. 6 is described with respect to forming, e.g., via a manufacturing assembly, accelerometer system 100 of FIG. 1. However, the techniques of FIG. 6 may be performed by a manufacturing assembly to form any of the components and/or alternative devices described herein. The techniques of FIG. 6 may be performed by a manufacturing assembly (e.g., an automated and/or semi-automated manufacturing assembly) and/or by one or more manufacturers.

A manufacturing assembly may determine Lorentz forces generated by each of coils 110 of accelerometer system 100 in response to motion of proof mass 104 (602). Accelerometer system 100 may generate two separate magnetic fields, each magnetic field applying a Lorentz force on proof mass 104. For example, a first magnetic flux loop formed by first magnet 220A, first pole piece 106A, first coil 110, and first non-moving member 108 may apply a first Lorentz force on proof mass 104 in a first direction along sense axis 201 and a second magnetic flux loop formed by second magnet 220B, second pole piece 106B, second coil 110B, and second non-moving member 108 may apply a second Lorentz force on proof mass 104 in a second direction along sense axis 201. In such examples, the Lorentz forces may act in opposite directions to inhibit movement of proof mass 104 along sense axis 201. As proof mass 104 moves along sense axis 201, a magnitude of one Lorentz force may decrease while a magnitude of an opposing Lorentz force may increase to maintain proof mass 104 in the null position, and allow processing circuitry 102 to sense the electrical signals required to maintain proof. The manufacturing assembly may simulate the movement of proof mass 104 from null position and determine the magnitudes of the Lorentz forces acting of proof mass 104 in response to the motion.

The manufacturing assembly may determine the magnetic flux values corresponding to the Lorentz forces (604). As the manufacturing assembly simulates movement of proof mass 104, the manufacturing assembly may determine changes in Lorentz forces as a result of the simulated movement. The manufacturing assembly may determine, based on the changes in Lorentz forces, changes in the magnetic flux as a result of the simulated movement.

The manufacturing assembly may determine whether a difference in magnitude between changes in magnetic flux of the two magnetic flux loops is less than or equal to a threshold value (606). In a balanced accelerometer system 100, wherein the first and second magnetic flux loops are symmetrical, there may be substantially no change in the net magnetic flux within accelerometer system 100 as proof mass 104 moves along sense axis 201. For example, in a balanced accelerometer system 100, as proof mass 104 moves towards the first magnetic flux loop and away from the second magnetic flux loop, the magnitude of the increase in the first magnetic flux may by substantially similar to the magnitude of the decrease in the second magnetic flux, and vice versa. The minimal change in net magnetic flux may isolate the outputs of accelerometer system 100 from the movement of proof mass 104, thereby increasing the accuracy of the outputs. The manufacturing assembly may identify the presence and magnitude of imbalance based on the differences in the magnitudes of the changes in the first and second magnetic fluxes in response to movement of proof mass 104. For example, the manufacturing assembly may determine whether for a same movement of proof mass 104, the first and second magnetic fluxes changed by the same amount. The manufacturing assembly may compare the difference in the amount of change against a threshold value. The threshold value may be up to 0.08 tesla (e.g., up to 0.077 tesla).

Based on a determination that the difference is less than or equal to the threshold value (“YES” branch of 606), the manufacturing assembly may complete assembly of accelerometer system 100 (610). The manufacturing assembly may determine that the first and second magnetic flux loops are balanced and complete assembly and/or testing of accelerometer system 100.

Based on a determination that the difference is more than the threshold value (“NO” branch of 606), the manufacturing assembly may adjust one or more features on one or more of one or more pole pieces 106 and/or one or more non-moving member 108 of accelerometer system (608). The manufacturing assembly may form features 240 and/or 402 on one or more pole pieces 106 and/or one or more non-moving members 108, respectively. Features 240 and/or 402 may create asymmetry in the shapes and dimensions of pole pieces 106 and/or non-moving members 108 of the different magnetic flux loops, thereby creating an asymmetry between the magnetic flux loops. The asymmetry formed by feature 240 and/or 402 may counteract the asymmetry identified by the manufacturing assembly, e.g., from the magnetic fluxes of the magnetic flux loops, to balance the first magnetic flux loop against the second magnetic flux loop.

After forming and/or adjusting the one or more features, the manufacturing assembly may perform each of steps 602-606 to determine if the one or more features creates balance between the first magnetic flux loop and the second magnetic flux loop. The manufacturing assembly may iteratively perform steps 602-608 until the manufacturing assembly determines that the magnetic flux loops are balanced (i.e., “YES” branch of 606).

This disclosure describes the following examples:

Example 1: an accelerometer system comprising: a first magnetic assembly comprising a first pole piece, a first magnet configured to generate a first magnetic flux, and a first excitation ring; a second magnetic assembly comprising a second pole piece, a second magnet configured to generate a second magnetic flux, and a second excitation ring, wherein a physical shape of the second pole piece is different than a physical shape of the first pole piece; a proof mass assembly comprising: a proof mass between the first magnetic assembly and the second magnetic assembly; a first coil disposed around the first pole piece, wherein the first magnetic flux flows from the first excitation ring to the first pole piece across the first coil, and wherein a magnitude of the first magnetic flux across the first coil is based on the physical shape of the first pole piece; and a second coil disposed around the second pole piece, wherein the second magnetic flux flows from the second excitation ring to the second pole piece across the second coil, and wherein a magnitude of the second magnetic flux across the second coil is based on the physical shape of the second pole piece; and processing circuitry configured to: cause a first current to flow through the first coil to apply a first Lorentz force to the proof mass; and cause a second current to flow through the second coil to apply a second Lorentz force to the proof mass.

Example 2: the accelerometer system of example 1, wherein the physical shape of the first pole piece comprises a first elongated body, and wherein the physical shape of the second pole piece comprises a second elongated body having a chamfer around an outer perimeter of the second elongated body.

Example 3: the accelerometer system of example 2, wherein the accelerometer system defines a longitudinal axis extending through the first magnetic assembly, the second magnetic assembly, and the proof mass assembly, and wherein the second elongated body extends from a first end to a second end along the longitudinal axis, wherein the first end of the second elongated body is affixed to the second magnet, wherein the second end of the second elongated body is disposed longitudinally between the first end of the second elongated body and the proof mass, and wherein the chamfer extends around an outer perimeter of the second end of the second elongated body.

Example 4: the accelerometer system of any of examples 2 or 3, wherein the chamfer defines a depth of up to 0.5 millimeters (mm).

Example 5: the accelerometer system of any of examples 2-4, wherein the chamfer comprises a first chamfer, and wherein the first elongated body defines a second chamfer around an outer perimeter of the first elongated body, the second chamfer defining a different depth than the first chamfer.

Example 6: the accelerometer system of any of examples 2-5, wherein the first elongated body defines a first cylinder, wherein the second elongated body defines a second cylinder, and wherein the outer perimeter of the second elongated body comprises an outer circumference of the second cylinder.

Example 7: the accelerometer system of any of examples 1-6, wherein the different physical shapes of the first pole piece and the second pole piece is configured to reduce a net change in magnetic flux within the accelerometer system in response to movement of the proof mass within the accelerometer system.

Example 8: the accelerometer system of example 7, wherein the net change in magnetic flux within the accelerometer system comprises a sum of an increase in one of the first magnetic flux or the second magnetic flux and a decrease in the other of first magnetic flux or the second magnetic flux in response to the movement of the proof mass.

Example 9: the accelerometer system of any of examples 1-8, wherein the different physical shapes of the first pole piece and the second pole piece reduces asymmetry between changes in the first Lorentz force and changes in the second Lorentz force in response to movement of the proof mass within the accelerometer system.

Example 10: an accelerometer system comprising: a first magnetic assembly comprising a first pole piece, a first magnet configured to generate a first magnetic flux, and a first excitation ring; a second magnetic assembly comprising a second pole piece, a second magnet configured to generate a second magnetic flux, and a second excitation ring; a proof mass assembly comprising: a proof mass between the first magnetic assembly and the second magnetic assembly; a first coil disposed around the first pole piece, wherein the first magnetic flux flows from the first excitation ring to the first pole piece across the first coil, and wherein a magnitude of the first magnetic flux across the first coil is based on a physical shape of the first pole piece; and a second coil disposed around the second pole piece, wherein the second magnetic flux flows from the second excitation ring to the second pole piece across the second coil, and wherein a magnitude of the second magnetic flux across the second coil is based on a physical shape of the second pole piece; and processing circuitry configured to: cause a first current to flow through the first coil to apply a first Lorentz force to the proof mass; and cause a second current to flow through the second coil to apply a second Lorentz force to the proof mass, wherein at least one pole piece of the first pole piece or the second pole piece defines a chamfer extending around an outer perimeter of the at least one pole piece.

Example 11: the accelerometer system of example 10, wherein the accelerometer system defines a longitudinal axis extending through the first magnetic assembly, the second magnetic assembly, and the proof mass assembly, and wherein the at least one pole piece extends from a first end to a second end along the longitudinal axis, wherein the second end is disposed longitudinally between the first end and the proof mass, and wherein the chamfer extends around an outer perimeter of the second end of the at least one pole piece.

Example 12: the accelerometer system of any of examples 10 or 11, wherein the chamfer defines a depth of up to 0.5 millimeters (mm).

Example 13: the accelerometer system of any of examples 10-12, wherein the first pole piece comprises a first cylinder, and wherein the second pole piece comprises a second cylinder.

Example 14: the accelerometer system of any of examples 10-13, wherein the chamfer extending around the outer perimeter of the at least one pole piece is configured to reduce a net change in magnetic flux within the accelerometer system in response to movement of the proof mass within the accelerometer system.

Example 15: the accelerometer system of example 14, wherein the net change in magnetic flux within the accelerometer system comprises a sum of an increase in one of the first magnetic flux of the second magnetic flux and a decrease in the other of the first magnetic flux of the second magnetic flux in response to the movement of the proof mass.

Example 16: the accelerometer system of any of examples 10-15, wherein the chamfer extending around the outer perimeter of the at least one pole piece is configured to reduce asymmetry between changes in the first Lorentz force and changes in the second Lorentz force in response to movement of the proof mass within the accelerometer system.

Example 17: an accelerometer system comprising: a first magnetic assembly comprising a first pole piece, a first magnet configured to generate a first magnetic flux, and a first excitation ring; a second magnetic assembly comprising a second pole piece, a second magnet configured to generate a second magnetic flux, and a second excitation ring, wherein a physical shape of the second excitation ring is different than a physical shape of the first excitation ring; a proof mass assembly comprising: a proof mass between the first magnetic assembly and the second magnetic assembly; a first coil disposed around the first pole piece, wherein the first magnetic flux flows from the first excitation ring to the first pole piece across the first coil, and wherein a magnitude of the first magnetic flux across the first coil is based on the physical shape of the first excitation ring; and a second coil disposed around the second pole piece, wherein the second magnetic flux flows from the second excitation ring to the second pole piece across the second coil, and wherein a magnitude of the second magnetic flux across the second coil is based on the physical shape of the second excitation ring; and processing circuitry configured to: cause a first current to flow through the first coil to apply a first Lorentz force to the proof mass; and cause a second current to flow through the second coil to apply a second Lorentz force to the proof mass.

Example 18: the accelerometer system of example 17, wherein the physical shape of the first excitation ring comprises a first elongated body, and wherein the physical shape of the second excitation ring comprises a second elongated body having a chamfer around an outer perimeter of the second elongated body.

Example 19: the accelerometer system of any of examples 17 or 18, wherein the different physical shapes of the first excitation ring and the second excitation ring are configured to reduce a net change in magnetic flux within the accelerometer system in response to movement of the proof mass within the accelerometer system.

Example 20: the accelerometer system of any of examples 17-19, wherein the different physical shapes of the first excitation ring and the second excitation ring are configured to reduce asymmetry between changes in the first Lorentz force and changes in the second Lorentz force in response to movement of the proof mass within the accelerometer system.

In one or more examples, the accelerometers described herein may utilize hardware, software, firmware, or any combination thereof for achieving the functions described. Those functions implemented in software may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure.

Instructions may be executed by one or more processors within the accelerometer or communicatively coupled to the accelerometer. The one or more processors may, for example, include one or more DSPs, general purpose microprocessors, application specific integrated circuits ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for performing the techniques described herein. Also, the techniques could be fully implemented in one or more circuits or logic elements.

The techniques of this disclosure may be implemented in a wide variety of devices or apparatuses that include integrated circuits (ICs) or sets of ICs (e.g., chip sets). Various components, modules, or units are described in this disclosure to emphasize functional aspects of devices configured to perform the disclosed techniques, but do not necessarily require realization by different hardware units. Rather, various units may be combined or provided by a collection of interoperative hardware units, including one or more processors as described above, in conjunction with suitable software and/or firmware.

What is claimed is:

1. An accelerometer system comprising:
a first magnetic assembly comprising a first pole piece, a first magnet configured to generate a first magnetic flux, and a first excitation ring;
a second magnetic assembly comprising a second pole piece, a second magnet configured to generate a second magnetic flux, and a second excitation ring, wherein a physical shape of the second pole piece is different than a physical shape of the first pole piece;
a proof mass assembly comprising:
a proof mass between the first magnetic assembly and the second magnetic assembly;
a first coil disposed around the first pole piece, wherein the first magnetic flux flows from the first excitation ring to the first pole piece across the first coil, and wherein a magnitude of the first magnetic flux across the first coil is based on the physical shape of the first pole piece; and
a second coil disposed around the second pole piece, wherein the second magnetic flux flows from the second excitation ring to the second pole piece across the second coil, and wherein a magnitude of the second magnetic flux across the second coil is based on the physical shape of the second pole piece; and
processing circuitry configured to:
cause a first current to flow through the first coil to apply a first Lorentz force to the proof mass; and
cause a second current to flow through the second coil to apply a second Lorentz force to the proof mass.

2. The accelerometer system of claim 1, wherein the physical shape of the first pole piece comprises a first elongated body, and wherein the physical shape of the second pole piece comprises a second elongated body having a chamfer around an outer perimeter of the second elongated body.

3. The accelerometer system of claim 2,
wherein the accelerometer system defines a longitudinal axis extending through the first magnetic assembly, the second magnetic assembly, and the proof mass assembly, and
wherein the second elongated body extends from a first end to a second end along the longitudinal axis, wherein the first end of the second elongated body is affixed to the second magnet, wherein the second end of the second elongated body is disposed longitudinally between the first end of the second elongated body and the proof mass, and wherein the chamfer extends around an outer perimeter of the second end of the second elongated body.

4. The accelerometer system of claim 2, wherein the chamfer defines a depth of up to 0.5 millimeters (mm).

5. The accelerometer system of claim 2, wherein the chamfer comprises a first chamfer, and wherein the first elongated body defines a second chamfer around an outer perimeter of the first elongated body, the second chamfer defining a different depth than the first chamfer.

6. The accelerometer system of claim 2, wherein the first elongated body defines a first cylinder, wherein the second elongated body defines a second cylinder, and wherein the outer perimeter of the second elongated body comprises an outer circumference of the second cylinder.

7. The accelerometer system of claim 1, wherein the different physical shapes of the first pole piece and the second pole piece is configured to reduce a net change in magnetic flux within the accelerometer system in response to movement of the proof mass within the accelerometer system.

8. The accelerometer system of claim 7, wherein the net change in magnetic flux within the accelerometer system comprises a sum of an increase in one of the first magnetic flux or the second magnetic flux and a decrease in the other of first magnetic flux or the second magnetic flux in response to the movement of the proof mass.

9. The accelerometer system of claim 1, wherein the different physical shapes of the first pole piece and the second pole piece reduces asymmetry between changes in the first Lorentz force and changes in the second Lorentz force in response to movement of the proof mass within the accelerometer system.

10. An accelerometer system comprising:
a first magnetic assembly comprising a first pole piece, a first magnet configured to generate a first magnetic flux, and a first excitation ring;
a second magnetic assembly comprising a second pole piece, a second magnet configured to generate a second magnetic flux, and a second excitation ring;
a proof mass assembly comprising:
a proof mass between the first magnetic assembly and the second magnetic assembly;
a first coil disposed around the first pole piece, wherein the first magnetic flux flows from the first excitation ring to the first pole piece across the first coil, and wherein a magnitude of the first magnetic flux across the first coil is based on a physical shape of the first pole piece; and
a second coil disposed around the second pole piece, wherein the second magnetic flux flows from the second excitation ring to the second pole piece across the second coil, and wherein a magnitude of the second magnetic flux across the second coil is based on a physical shape of the second pole piece; and
processing circuitry configured to:
cause a first current to flow through the first coil to apply a first Lorentz force to the proof mass; and
cause a second current to flow through the second coil to apply a second Lorentz force to the proof mass,
wherein at least one pole piece of the first pole piece or the second pole piece defines a chamfer extending around an outer perimeter of the at least one pole piece.

11. The accelerometer system of claim 10, wherein the accelerometer system defines a longitudinal axis extending through the first magnetic assembly, the second magnetic assembly, and the proof mass assembly, and
wherein the at least one pole piece extends from a first end to a second end along the longitudinal axis, wherein the second end is disposed longitudinally between the first end and the proof mass, and wherein the chamfer extends around an outer perimeter of the second end of the at least one pole piece.

12. The accelerometer system of claim 10, wherein the chamfer defines a depth of up to 0.5 millimeters (mm).

13. The accelerometer system of claim 10, wherein the first pole piece comprises a first cylinder, and wherein the second pole piece comprises a second cylinder.

14. The accelerometer system of claim 10, wherein the chamfer extending around the outer perimeter of the at least one pole piece is configured to reduce a net change in magnetic flux within the accelerometer system in response to movement of the proof mass within the accelerometer system.

15. The accelerometer system of claim 14, wherein the net change in magnetic flux within the accelerometer system comprises a sum of an increase in one of the first magnetic flux of the second magnetic flux and a decrease in the other of the first magnetic flux of the second magnetic flux in response to the movement of the proof mass.

16. The accelerometer system of claim 10, wherein the chamfer extending around the outer perimeter of the at least one pole piece is configured to reduce asymmetry between changes in the first Lorentz force and changes in the second Lorentz force in response to movement of the proof mass within the accelerometer system.

17. An accelerometer system comprising:
a first magnetic assembly comprising a first pole piece, a first magnet configured to generate a first magnetic flux, and a first excitation ring;
a second magnetic assembly comprising a second pole piece, a second magnet configured to generate a second magnetic flux, and a second excitation ring, wherein a physical shape of the second excitation ring is different than a physical shape of the first excitation ring;
a proof mass assembly comprising:
a proof mass between the first magnetic assembly and the second magnetic assembly;
a first coil disposed around the first pole piece, wherein the first magnetic flux flows from the first excitation ring to the first pole piece across the first coil, and wherein a magnitude of the first magnetic flux across the first coil is based on the physical shape of the first excitation ring; and
a second coil disposed around the second pole piece, wherein the second magnetic flux flows from the second excitation ring to the second pole piece across the second coil, and wherein a magnitude of the second magnetic flux across the second coil is based on the physical shape of the second excitation ring; and
processing circuitry configured to:
cause a first current to flow through the first coil to apply a first Lorentz force to the proof mass; and
cause a second current to flow through the second coil to apply a second Lorentz force to the proof mass.

18. The accelerometer system of claim 17, wherein the physical shape of the first excitation ring comprises a first elongated body, and wherein the physical shape of the second excitation ring comprises a second elongated body having a chamfer around an outer perimeter of the second elongated body.

19. The accelerometer system of claim 17, wherein the different physical shapes of the first excitation ring and the second excitation ring are configured to reduce a net change in magnetic flux within the accelerometer system in response to movement of the proof mass within the accelerometer system.

20. The accelerometer system of claim 17, wherein the different physical shapes of the first excitation ring and the second excitation ring are configured to reduce asymmetry between changes in the first Lorentz force and changes in the second Lorentz force in response to movement of the proof mass within the accelerometer system.
